(19) United States
(12) Patent Application Publication
(10) Pub. No.: US 2023/0109707 A1
(43) Pub. Date: Apr. 13, 2023

(54) ROBOT INSTALLED UTILITY LINE HARDWARE

(71) Applicant: PREFORMED LINE PRODUCTS CO., Mayfield Village, OH (US)

(72) Inventors: Douglas BELL, Mayfield Village, OH (US); Benjamin Franklin CIESIELCZYK, Madison, OH (US); John MARKIEWICZ, Mentor, OH (US)

(21) Appl. No.: 17/964,713

(22) Filed: Oct. 12, 2022

Related U.S. Application Data
(60) Provisional application No. 63/254,761, filed on Oct. 12, 2021.
(60) Provisional application No. 63/254,763, filed on Oct. 12, 2021.
(60) Provisional application No. 63/254,767, filed on Oct. 12, 2021.
(60) Provisional application No. 63/254,774, filed on Oct. 12, 2021.

(51) Int. Cl. H02G 1/02; B25J 11/00; B64C 39/02

(52) U.S. Cl. CPC H02G 1/02; B25J 11/005; B64C 39/024

(57) ABSTRACT

One or more devices and associated methods for in situ performance of work on a line that is suspended are provided. A device includes a saddle portion to receive the line therein. The device includes a motive portion that engages the line and moves the device along the line. The device includes an operation portion that includes a mechanism operating to perform a work task at a location along the line.

### RELATED APPLICATION(S)

This application claims priority to provisional applications U.S. Pat. No. 63,254,761, filed on Oct. 12, 2021, entitled “ROBOT INSTALLED POWER LINE HARDWARE”, U.S. Pat. No. 63,254,763, filed on Oct. 12, 2021, entitled “DRONE INSTALLED BOLTED HARDWARE”, U.S. Pat. No. 63,254,767, filed on Oct. 12, 2021, entitled “TWIN SPACER DRONE INSTALL SYSTEM”, U.S. Pat. No. 63,254,774, filed on Oct. 12, 2021, entitled “SPACER END CLAMP”, all of which are incorporated by reference herein in their entirety.

### TECHNICAL FIELD

The present disclosure relates generally to in situ work upon utility lines, such as power/communication lines (e.g., a power transmission line). In an example, the present disclosure relates to in situ installation of hardware equipment onto a utility line.

### BACKGROUND

Many power/communication lines extend in a suspended manner, in air, by towers, poles or the line. In situ (i.e., in place) work upon such a power/communication line thus involves work at location(s) spaced up and away from terrain (i.e., spaced up and away from ground, building(s), water or the like).

In situ work upon such a power/communication line may be performed by one or more linemen or line technicians, possibly with the aid of hot stick(s) for safety. Performance of work by a line technician often includes placing the line technician within a working distance of the power/communication line upon which work is performed. Such placement of a line technician within a working distance of a power/communication line may include the use of a ladder, a lift apparatus (e.g., a bucket truck), a helicopter, or similar.

Working along an extended length of such a power/communication line may include a need to move/reposition an ancillary device (e.g., ladder, lift apparatus, helicopter, or similar) used to place the line technician within a working distance of the power/communication line.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

In accordance with one or more aspects, the present disclosure provides a device for in situ performance of work on a line. The device includes a saddle portion to receive the line therein. The device includes a motive portion that engages the line and moves the device along the line. The device includes an operation portion that includes a mechanism operating to perform a work task at a location along the line.

In accordance with one or more aspects, the present disclosure provides a method of in situ performance of work on a line. The method includes providing a device. The device includes a saddle portion that receives the line therein. The device includes a motive portion that engages the line and moves the device along the line. The device includes an operation portion that includes a mechanism that operates to perform a work task at a location along the line. The method includes moving the device onto the line such that the line is received within the saddle portion. The method includes moving the device along the line via the motive portion. The method includes performing the task with the operating portion.

In accordance with one or more aspects, the present disclosure provides a device for in situ performance of work on a line. The device includes a saddle portion to receive the line therein. The device includes at least one of a motive portion that engages the line and moves the device along the line or an operation portion that includes a mechanism operating to perform a work task at a location along the line.

The following description and annexed drawings set forth certain illustrative aspects and implementations. These are indicative of but a few of the various ways in which one or more aspects may be employed. Other aspects, advantages, and/or novel features of the disclosure will become apparent from the following detailed description when considered in conjunction with the annexed drawings.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is perspective illustration, partially transparent, of example device for performing work at a location of a suspended line in accordance with at least one aspect of the present disclosure, and also shows an example piece of hardware for a line.

FIG. 2 is an enlarged view of a portion of the example device of FIG. 1 and the example piece of hardware in accordance with at least one aspect of the present disclosure.

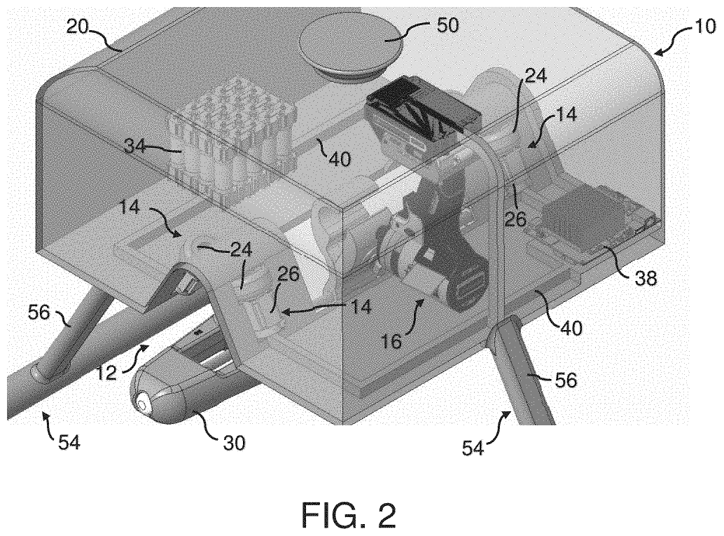

FIG. 3 is a further enlarged view of a portion of the example device of FIG. 1 and the example piece of hardware in accordance with at least one aspect of the present disclosure.

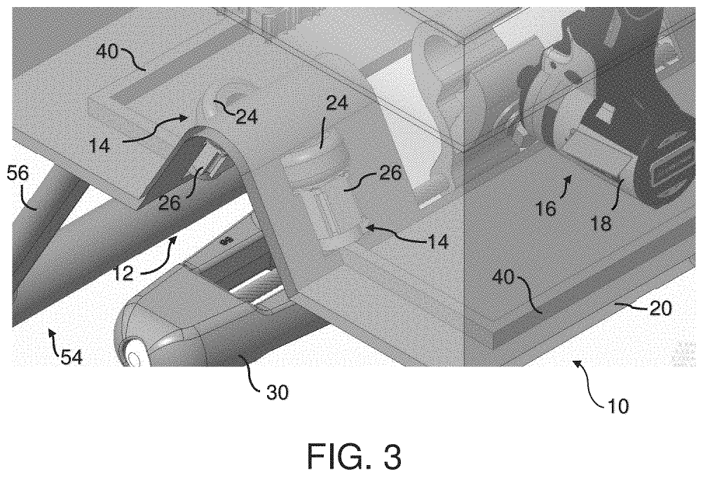

FIG. 4 is a view, partially transparent, of the example device of FIG. 1, and the example piece of hardware, as would be viewed along or into a length of a line in accordance with at least one aspect of the present disclosure.

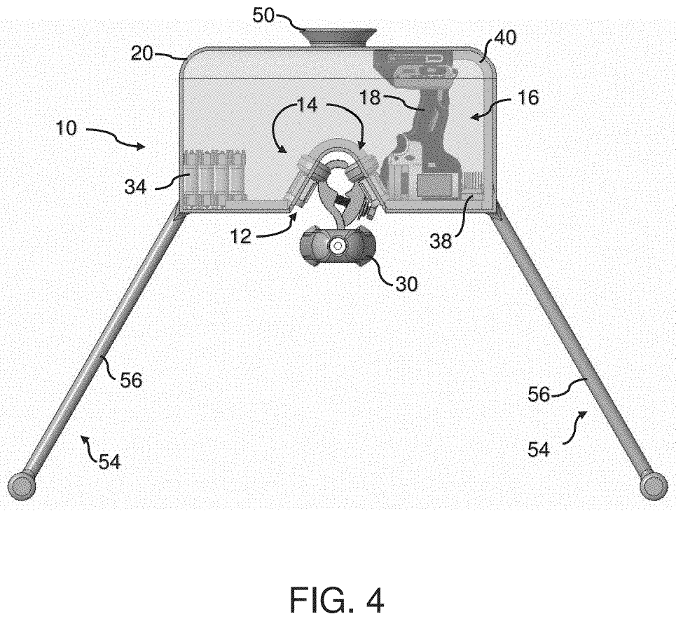

FIG. 5 is a side view, partially transparent, of the example device of FIG. 1 and the example piece of hardware in accordance with at least one aspect of the present disclosure.

FIG. 6 is an enlarged perspective view, partially transparent, of the example device of FIG. 1 and the example piece of hardware in accordance with at least one aspect of the present disclosure.

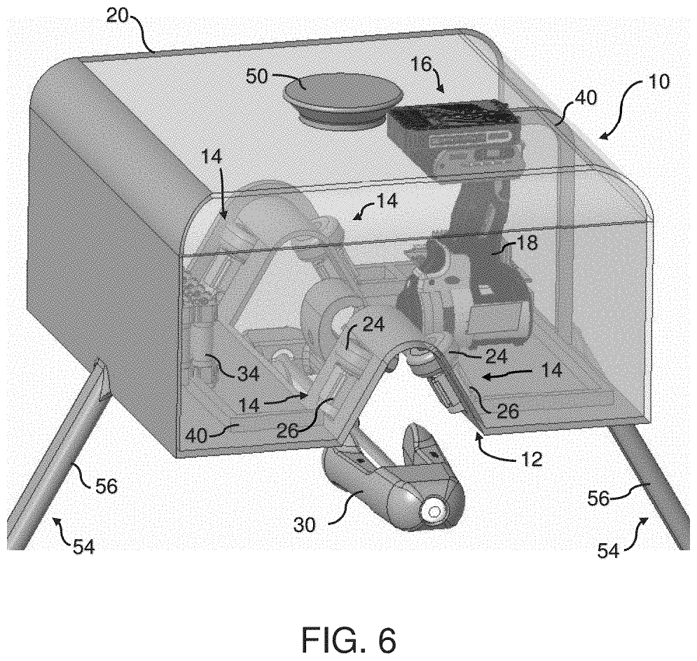

FIG. 7 is a perspective view an example flying mechanism engaged with another example device in accordance with at least one aspect of the present disclosure.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

Certain terminology is used herein for convenience only and is not to be taken as a limitation on the disclosed subject matter. Relative language used herein is best understood with reference to the drawings, in which like numerals are used to identify like or similar items. Further, in the drawings, certain features may be shown in somewhat schematic form. The drawing sheets, and content contained thereon, are incorporated into this specification, and thus the patent application, by reference.

The following subject matter may be embodied in a variety of different forms, such as methods, devices, components, and/or systems. Accordingly, this subject matter is not intended to be construed as limited to any illustrative embodiments set forth herein as examples. Rather, the embodiments are provided herein merely to be illustrative.

The claimed subject matter is now described with reference to the drawings, wherein like reference numerals are generally used to refer to like elements throughout. In the following description, for purposes of explanation, numerous specific details are set forth in order to provide an understanding of the claimed subject matter. It is evident, however, that the claimed subject matter may be practiced without these specific details. In other instances, structures and devices are illustrated in block diagram form in order to facilitate describing the claimed subject matter. Relative size, orientation, etc. of parts, components, etc. may differ from that which is illustrated while not falling outside of the scope of the claimed subject matter.

Herein the term line is to be accorded a broad interpretation. The line may be a cable and/or the like. The line may include metal (e.g., copper, aluminum or the like) or other materials (e.g., fiber). Also, the line may be for transmission of electrical energy, transmission of communications or other functions. The line is suspended in air, typically at a height that increases challenge of accessing the line and extends for an expanse that increases challenge of accessing the line. The line may be generally considered to be a utility line. Such includes a transmission line and/or similar (e.g., suspended by utility pole, etc.).

Currently, most power line equipment (e.g., products, hardware) is installed via a line technician in a bucket truck or helicopter. A current way to install equipment onto lines is to install the products by hand, either by linemen themselves or with hot sticks. These methods of installation always carry same amount of risk for the line technician due to the heights at which they are working. These methods can also get very expensive depending on the location and ease of access of the line.

In accordance with an aspect, the present disclosure provides a device, such as a robot, for performing work at a location of a suspended line. The device (e.g., robot) includes at least one device for performing a work task associated with the line. The device includes an arrangement for receipt and retention of the device upon the line. Also, the present disclosure provides a method of work performance, via a device, such as a robot, at a location of a suspended line. The method includes receipt and retention of a device upon the line via a receipt and retention arrangement of the device. The method includes performing a work task associated with the line.

In accordance with at least one aspect of the present disclosure, a device (e.g., robot), either autonomous or remote controlled, is placed on a line, and then performs at least one work task upon the line. For example, such a work task may be installation of a piece of equipment upon the line. The equipment may be any of a variety of products.

The device (e.g., robot) could be placed on the line via a line technician in a bucket truck, a drone with a tether, a drone with a special attachment system, or the device could be designed somewhat like a drone and can land itself on the line. Once the device is on the line, it would not need assistance from the line technician or the drone until it's time to remove the device. The device could have a system that allows it to travel along the line. The robot could have a system that allows it to install (e.g., place, locate, secure, affix, etc.) a specific product onto the line. The device could have interchangeable systems that allow it to install different types of products onto the line.

In accordance with at least one aspect of the present disclosure, the device (e.g., robot) would be placed onto the line. There may be several methods for line placement. Four example methods included: 1) Placed on the line by a line technician; 2) Attached to a drone via a tether and flown onto the line; 3) Attached directly to a drone via a custom attachment/quick release system and flown onto the line; and. 4) The robot itself has drone capabilities and can fly/land itself on the line.

The device (e.g., robot) includes an arrangement for receipt and retention of the device upon the line. In part, such may include a counterbalance system to keep the device steady on the line.

The device (e.g., robot) may include an arrangement for moving the robot along the line. Within an example, such may include at least one wheel that engages the line and is powered to rotate. Via the arrangement for moving the device along the line, once upon the line, the device may thus have ability to pull/push/drive itself along the length of the line.

Within an example, the device (e.g., robot) may also have a system that allows it to determine distance so it knows how far along the line it has traveled.

The device (e.g., robot) may have several interchangeable systems that allow it to install multiple products. Examples of such include, but are not limited to, bolted hardware (e.g., twin spacers, Vortx dampers, etc.), helical hardware, bird flight diverters, and marker balls.

In accordance with one or more aspects, the present disclosure provides a device for in situ performance of work on a suspended line. The device includes a saddle portion to receive the line therein. The device includes a motive portion that engages the suspended line and moves the device along the line. The device includes an operation portion that includes a mechanism operating to perform a work task at a location along the line.

In accordance with one or more aspects, the present disclosure provides a method of in situ performance of work on a suspended line. The method includes providing a device. The device includes a saddle portion that receives the line therein. The device includes a motive portion that engages the suspended line and moves the device along the line. The device includes an operation portion that includes a mechanism that operates to perform a work task at a location along the line. The method includes moving the device onto the line such that the line is received within the saddle portion. The method includes moving the device along the line via the motive portion of the device. The method includes performing the task with the operating portion.

As mentioned, a current way to install helical products onto power/communication lines is to install the products by hand, either by line technicians themselves or with hot sticks. However, the present disclosure provides a way to make installations safer, faster, and less expensive. As mentioned, such may involve using a drone. The drone, rather than one or more linemen, goes up (i.e., via flying of the drone) to the line to install the helical products.

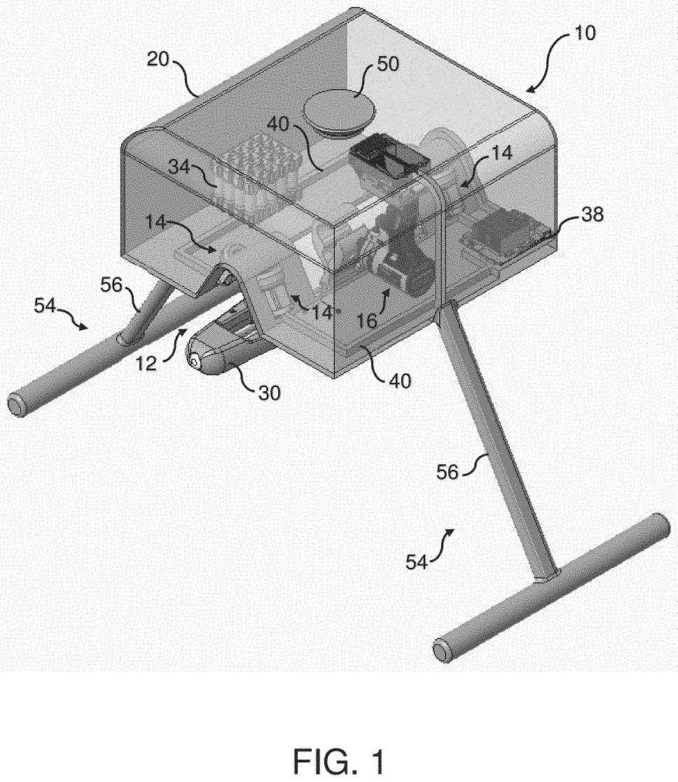

FIG. 1 shows an example of a device 10 accordance with one or more aspects of the present disclosure. The device 10 is intended to operate away from a line technician and as such may be considered to be a robot. As mentioned, the device 10 is for in situ performance of work on a suspended utility line or similar. Specifically, the in situ performance occurs while the line remains suspended. Accordingly, the device 10 is to be placed, attach or the like to the line and the device has a portion 12 to accomplish such attachment.

Specifically, the device has a saddle portion 12 that receives the line in the saddle portion. It is to be appreciated that the saddle portion 12 may have a variety of constructions and configurations that are within the scope of the present disclosure and thus the saddle portion 12 is to be broadly interpreted. The saddle portion 12 may cooperate with the line such that the saddle portion 12 is above the line, is located on one or more sides of the line or may envelop the line. As such, the line is generally considered as being received by the saddle portion 12.

As mentioned, the device (e.g., robot) 10 has the ability to move along the line. Accordingly, the device 10 has a motive portion 14 that engages the line and moves the device along the line. It is to be appreciated that the motive portion 14 may have a variety of constructions and configurations that are within the scope of the present disclosure and thus the saddle portion is to be broadly interpreted. Engagement with the line may be at a top of the line, one or more sides of the line, a bottom of the line, encircling of the line, etc.

As mentioned, the device (e.g., robot) 10 performs work (e.g., a work task) at a location along the line. The device 10, includes an operation portion 16 to perform the work. It is to be appreciated that the operation portion 16, and an operating mechanism 18 thereof, may have a variety of constructions and configurations that are within the scope of the present disclosure and thus the operation portion 16 is to be broadly interpreted. To be sure, the specifics of the operation portion 16, and the operating mechanism 18, are guided by the work task to be performed.

Focusing upon the example device 10 of FIG. 1, the example has a body 20. Within the body 20, as least some of the portions of the device 10 are located. Also, within the shown example, note that the body 20 has a recess extending along a bottom of the body. Within the example, such recess may be part of an example of the saddle portion 12. Within such example, the line may be received within the recess such that the body 20 is located primarily above the line. It is worth noting that the body 20 may also extend to left and right sides of the line. So, such may be considered to be an example of the saddle portion 12 is configured to be located above the line. Again, such location of the saddle portion 12 is only an example and variation (e.g., an encircling saddle portion), is contemplated.

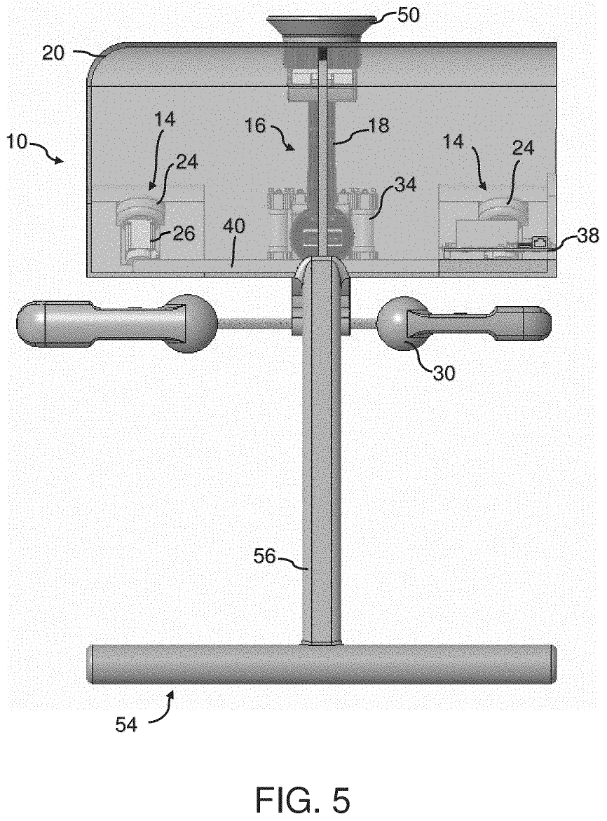

As mentioned, some of the portions of the device 10 may be located within the body 20. Also, recall that the device 10 has a motive portion 14. Within the example of FIG. 1, the motive portion 14 is within the body 20. The specific example of the motive portion 14 includes at least one wheel 24 to engage the utility line and a motor 26 to rotate the wheel. Within the example, two pairs of such wheels 24 and motors 26 are provided. See FIG. 5. The pairs of wheels 24 and associated motors 26 are located at the saddle portion 12 (e.g., the recess). Also, for each pair, one wheel 24 and associated motor 26 are located on one side (e.g., a left side) of the recess and the other wheel and associated motor are located on another side (e.g., a right side) of the recess. So, when the line is within the saddle portion 12 (e.g., the recess), the wheels 24 engage the left and right sides of the line. It is to be appreciated that the wheels 24 may be tilted at respective angles as shown within the example of FIG. 1. When the motors 26 are energized, the wheels 24 turn and cause movement (e.g., a driving movement) of the device 10 along the line.

Again as mentioned, some of the portions of the device 10 may be located within the body 20 and device has the operation portion 16 to perform a work task. Within the example of FIG. 1, the operation portion 16 is within the body 20. The specific example of the operating mechanism 18 the operation portion 16 includes a driver, and specifically a driver that is a hand power tool. Of course, the tool need not be limited to a driver and certainly need not be limited to a hand power tool. But, the tool being a driver does have usefulness for many applications and a hand power tool may provide for ease of provision/exchange (i.e., possible avoidance of a custom-constructed tool). But, to be clear, the tool may be any tool, including a custom-constructed tool. Accordingly, such is to be broadly interpreted and is to be understood to be within the scope of the present disclosure.

Also, the operation portion 16 may include additional mechanisms, such as mechanism(s) to move the operating mechanism 18 into a position to permit the work task to be completed. Examples of such additional mechanisms may include servo-positioners. The construction and configuration of such additional mechanisms may be varied (e.g., variations to accommodate various operating mechanisms, various types of positioning movements, etc.). It is to be appreciated that the scope of such is to be broadly interpreted and such appreciation is within the present disclosure.

At this point it is to be noted that FIG. 1 also shows an example piece of equipment 30 that is for installation onto the line via a work task performed by the device 10. The example piece of equipment 30 is a damper. However, it is to be appreciated that equipment many be varied and that such varied pieces of are within the scope of the present disclosure.

Also, it is to be noted that the example piece of equipment 30 is to be attached to the line via a clamp secured via at least one rotational member (e.g., a bolt or other type of turnable member). Such example is logical in view of the shown example of the operation portion 16 including a driver. However, it is to be recalled and appreciated that different equipment, and thus different securing structures, are contemplated and within the scope of the present disclosure. Again, it is to be recalled and appreciated that different operation portions are contemplated and within the scope of the present disclosure.

It is to be appreciated that the device, 10 and in particular the motive portion 14 and the operation portion 16, need to be powered. As such, the device 10 includes a power source 34. The specifics of the power source 34 may be varied and such variations are within the scope of the present disclosure. Within the shown example, the power source 34 includes a battery pack. The specifics (e.g., capacity) of the battery pack may be varied and such variations are within the scope of the present disclosure.

As mentioned, movement along the line, via the motive portion 14, and performance of work, via the operation portion 16, are performed by the device. However, it is to be recalled that such occurs along the line and thus away from the linemen technician. In order to accomplish such functions, the device 10 includes a controller 38 to control the motive portion 14 and the operation portion 16.

The controller 38 may have a variety of constructions and configurations. Examples of such constructions and configurations include various circuitry, processors performing algorithms and/or programs, memories to store such algorithms and/or programs and combinations thereof. The controller 38, the motive portion 14, the operation portion 16, the power source 34, and possibly other portions are electrically connected with an appropriate electrical arrangement 40 that may be dependent upon the specifics of the various portions. It is to be appreciated that the specifics of the controller 38 and the electrical arrangement 40 may be varied. The variations are dependent, in part, upon the specific of the motive portion, the operation portion, etc. It is to be appreciated that the variations are contemplated and within the scope of the present disclosure.

It is to be further appreciated that the device 10, including the controller 38, may be constructed and configured to operate autonomously, once the device is upon the line, or via remote control, or a combination of both. As such, the device 10 may be considered to be a robot, as mentioned. It is to be appreciated that, if operation is autonomously, the controller 38 is to be constructed and configured, e.g., provided within suitable algorithms and/or programs, to complete the desired work. It is to be appreciated that, if operation includes some amount of remote control, the device 10 will include structure to receive remote control signals. Within one example, the structure to receive signals is part of the controller 38. Within another example, the structure to receive signals is associated with the controller 38. It is to be appreciated, that if operation includes some amount of remote control, the controller 38 is to be constructed and configured, e.g., provided within suitable algorithms and/or programs, to response to such remote-control signals.

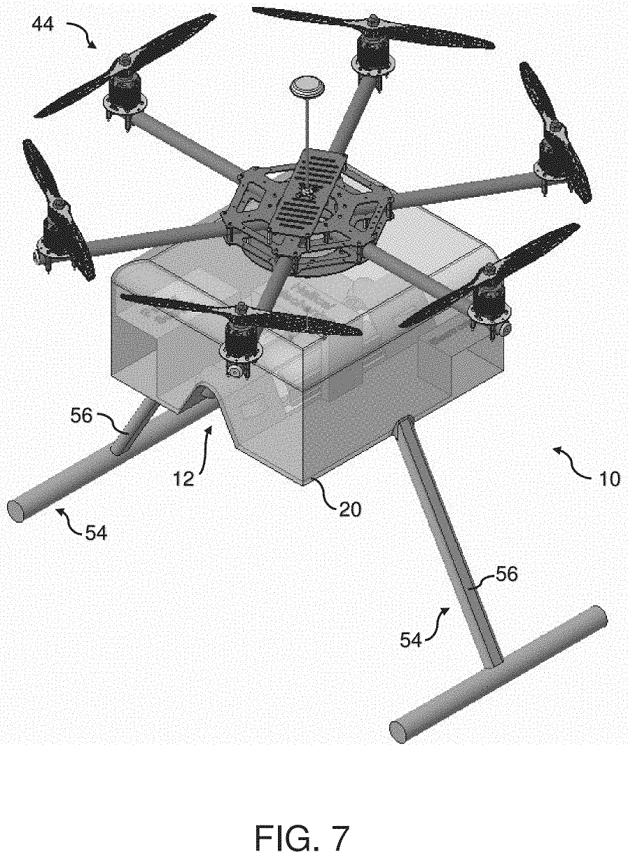

As mentioned, the device 10 is placed upon the line, and then the device is to move along the line and to perform work along the line. There are two options as to placement of the device 10 upon the line. The first option is manual placement (e.g., a line technician lifting the device 10 to the line via a lift such as a bucket truck). The second option is lifting the device 10 via a flying mechanism 44. See FIG. 7. An example of a flying mechanism 44 is a flying drone. Such flying drone may be remotely controlled. However, other flying mechanisms (e.g., helicopter) are contemplated and within the scope of the present disclosure. Also, it is to be appreciated that the flying mechanism 44 any be integrated with the device 10 (i.e., the flying mechanism and the device remain together) or the flying mechanism may selectively be coupled to and decoupled to the device.

For the example in which the flying mechanism 44 selectively couples/decouples the device 10, the flying mechanism is selectively coupled to the device to lift the device to the line and then decouples from the device. The device 10 is then able to move and operate to accomplish work on the line. Once work is accomplished, or removal of the device 10 from the line is otherwise desired, the flying mechanism 44 may be flown to the device and recoupled to the device. The flying mechanism 44, with the coupled device 10, are then flown back to ground. It is to be appreciated that variations are possible, contemplated and within the scope of the present disclosure.

The example device (e.g., robot) 10 shown within the figures is configured to couple and cooperate with a drone as the flying mechanism 44. FIG. 1 shows the example device 10 with an example drone attachment point 50. See also that FIG. 7 shows the example device 10 coupled to the flying mechanism 44, which is a drone.

Within the shown example (e.g., FIG. 1), the drone attachment point 50 is a short, inverted truncated cone on the device 10. The drone (FIG. 7) has a mechanism to selectively grasp and release the cone.

Again, it is to be appreciated that the device 10 may have a variety of constructions and configurations. Recall that within the show example, the device 10 has the body 20. The drone attachment point 50 may be located at a top of the body 20, as shown within the example. Of course, the location may be varied (e.g., attachment points may be located on sides of the body for the drone to grasp from the sides of the body).

Also, it is to be appreciated that the shown example, is configured such that the body 20 is mostly located above the line when the device 10 is located upon the line (i.e., the line is received within the saddle portion 12). It is possible that such, alone, may tend to induce balancing instability. As such, the device 10 may include a counterbalance system 54 to keep the device 10 steady on the line.

Within the shown example, the counterbalance system 54 includes appendages 56 that extend downwardly from the body 20. Weighted portions may be included on the appendages. Presence of the counterbalance system 54 may provide for the overall center to mass of the device 10 to be below the saddle portion 12 and thus below the line when the device 10 is on the line.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first location and a second location correspond to location A and location B or two different or two identical locations or the same location.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are to be construed to mean “one or more” unless specified otherwise or clear from context to be directed to a singular form. Also, at least one of A and B or the like means A or B or both A and B. Furthermore, to the extent that “includes”, “having”, “has”, “with”, or variants thereof are used in either the detailed description or the claims, such terms are intended to be inclusive in a manner similar to “comprising”.

Also, although the disclosure has been illustrated and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A device for in situ performance of work on a line, the device comprising:
a saddle portion receiving the line therein;
a motive portion engaging the line and moving the device along the line; and
an operation portion that comprises a mechanism operating to perform a work task at a location along the line.

2. The device as set forth in claim 1, wherein the saddle portion is configured to be located above the line such that the saddle portion is pulled toward the line by gravity.

3. The device as set forth in claim 2, comprising a counterweight located below or coplanar with the saddle portion.

4. The device as set forth in claim 3, wherein the counterweight provides a stand for the device when the device is located on ground.

5. The device as set forth in claim 1, comprising a portion engageable by a flying mechanism to lift the device to the line.

6. The device as set forth in claim 5, wherein the flying mechanism is a drone.

7. The device as set forth in claim 5, wherein the flying mechanism is detachable from the portion.

8. The device as set forth in claim 1, wherein the motive portion comprises a wheel to engage the line and a motor to rotate the wheel.

9. The device as set forth in claim 1, comprising a battery to power at least one of the motive portion or the operation portion.

10. The device as set forth in claim 1, wherein the device comprises a controller to control at least one of the motive portion or the operation portion.

11. The device as set forth in claim 10, wherein the controller is autonomous to control at least one of the motive portion or the operation portion once the line is received within the saddle portion.

12. The device as set forth in claim 10, wherein the controller receives instructions from a location remote from the device to control at least one of the motive portion or the operation portion once the line is received within the saddle portion.

13. The device as set forth in claim 10, wherein the controller is configured to operate in a remote control mode to receive instructions from a location remote from the device to control at least one of the motive portion or the operation portion once the line is received within the saddle portion and an autonomous mode to control at least one of the motive portion or the operation portion once the line is received within the saddle portion.

14. The device as set forth in claim 1, wherein operation portion comprises a driver.

15. The device as set forth in claim 14, wherein the driver is a hand power tool.

16. A method of in situ performance of work on a line, the method comprising:
providing a device that comprises:
a saddle portion receiving the line therein;
a motive portion engaging the line and moving the device along the line; and
an operation portion that comprises a mechanism operating to perform a work task at a location along the line;
moving the device onto the line such that the line is received within the saddle portion;
moving the device along the line via the motive portion; and
performing the task with the operating portion.

17. The method as set forth in claim 16, wherein moving the device onto the line comprises lifting the device to the line with a flying mechanism.

18. The method as set forth in claim 16, wherein at least one of moving the device along the line or performing the task is autonomous once the line is received within the saddle portion.

19. The method as set forth in claim 16, wherein at least one of moving the device along the line or performing the task is remotely controlled once the line is received within the saddle portion.

20. A device for in situ performance of work on a line, the device comprising:
a saddle portion receiving the line therein; and
at least one of:
a motive portion engaging the line and moving the device along the line; or
an operation portion that comprises a mechanism operating to perform a work task at a location along the line.
